(19) United States
(12) Patent Application Publication
(10) Pub. No.: US 2025/0298991 A1
(43) Pub. Date: Sep. 25, 2025

(54) METHOD AND SYSTEM FOR GENERATING CUSTOMIZED MODEL EXPLANATIONS VIA ARTIFICIAL INTELLIGENCE

(71) Applicant: JPMorgan Chase Bank, N.A., New York, NY (US)

(72) Inventors: Allan ANZAGIRA, Long Island City, NY (US); Freddy LECUE, Mamaroneck, NY (US); Daniele MAGAZZENI, London (GB)

(73) Assignee: JPMorgan Chase Bank, N.A., New York, NY (US)

(21) Appl. No.: 18/614,165

(22) Filed: Mar. 22, 2024

(51) Int. Cl. G06F 40/40

(52) U.S. Cl. CPC G06F 40/40

(57) ABSTRACT

A method for generating customized model explanations via a model is disclosed. The method includes generating, via the model, a prompt in a natural language format based on a received request for an explanation of model outputs, the request including feature attributions and corresponding subject information; modifying, via the model, the prompt based on predetermined guidelines to generate a test response; validating, via the model, the test response by determining whether errors are detected in the test response; performing, via the model when the errors are detected, corrective actions that resolve each of the detected errors by altering the prompt; tuning, via the model, the altered prompt based on response attributes; and generating, via the model, a model explanation in the natural language format based on the tuned prompt.

### BACKGROUND

### 1. Field of the Disclosure

This technology generally relates to methods and systems for providing customized model explanations, and more particularly to methods and systems for providing customized explanations of machine learning model outputs by utilizing automated prompt modification and composition via artificial intelligence.

### 2. Background Information

Many business entities operate various artificial intelligence systems such as, for example, generative machine learning models to process and provide insight into large collections of data. Often, instructions are provided to these generative machine learning models via natural language prompts. Historically, implementations of conventional prompt modification and composition techniques have resulted in varying degrees of success with respect to generating effective prompts that optimize generative machine learning model responses.

One drawback of using the conventional prompt modification and composition techniques is that in many instances, accuracy of a generated model response is directly related to a quality of a corresponding prompt. As a result, inaccurate model responses are generated by well-trained generative machine learning models due to ineffectively generated prompts. Additionally, inefficient expenditures of resources are required to generate the model response due to inefficiencies related to the processing of ineffectively generated prompts.

Therefore, there is a need to provide customized explanations of machine learning model outputs that are accurate and resource efficient by utilizing automated prompt modification and composition via artificial intelligence.

### SUMMARY

The present disclosure, through one or more of its various aspects, embodiments, and/or specific features or sub-components, provides, inter alia, various systems, servers, devices, methods, media, programs, and platforms for providing customized explanations of machine learning model outputs by utilizing automated prompt modification and composition via artificial intelligence.

According to an aspect of the present disclosure, a method for generating customized model explanations via at least one model is disclosed. The method is implemented by at least one processor. The method may include generating, via the at least one model, a prompt in a natural language format based on a received request for an explanation of at least one model output, the request may include at least one feature attribution and corresponding subject information; modifying, via the at least one model, the prompt based on at least one predetermined guideline to generate a test response; validating, via the at least one model, the test response by determining whether at least one error is detected in the test response; performing, via the at least one model when the at least one error is detected, at least one corrective action that resolves each of the at least one detected error by altering the prompt; tuning, via the at least one model, the altered prompt based on at least one response attribute; and generating, via the at least one model, a model explanation in the natural language format based on the tuned prompt.

In accordance with an exemplary embodiment, each of the at least one predetermined guideline may relate to an automated prompt modification procedure that is usable to structure data in the prompt, and the automated prompt modification procedure may include a prompt composition requirement and a prompt modification order requirement.

In accordance with an exemplary embodiment, the prompt composition requirement may relate to a predetermined configuration of the data in the prompt, and the prompt composition requirement may include at least one from among a persona requirement that describes a role for adoption by the at least one model, a task outline requirement that references model inputs, a model directive requirement that provides instructions for completing requested tasks, and an input definition requirement that describes the model inputs.

In accordance with an exemplary embodiment, the prompt modification order requirement may relate to a predetermined sequence of modification actions that is usable to change the prompt, and the predetermined sequence may include at least one from among a persona verification action, a task outline verification action, a model directive verification action, and a prompt input verification action.

In accordance with an exemplary embodiment, the validating of the test response includes error determination and self-consistency determination that are performed by the at least one model, the self-consistency determination may relate to a factual accuracy validation of sources utilized by the at least one model.

In accordance with an exemplary embodiment, the error determination may include at least one from among technical error validation that relates to identification of domain concept misinterpretations in the test response and input-output validation that substantiates the test response based on the modified prompt.

In accordance with an exemplary embodiment, the at least one response attribute may define desired output formatting for the model explanation, and the at least one response attribute may include at least one from among a formatting attribute that defines an arrangement of information in the model explanation, a clarity attribute that defines a type of the information for inclusion in the model explanation, and a conciseness attribute that defines an amount of the information for inclusion in the model explanation.

In accordance with an exemplary embodiment, the prompt may correspond to a formulation of natural language text that provides a plurality of instructions to a machine learning model for performance of a task.

In accordance with an exemplary embodiment, the at least one model may include at least one from among a large language model, a deep learning model, a neural network model, a natural language processing model, a machine learning model, a mathematical model, and a process model.

According to an aspect of the present disclosure, a computing device configured to implement an execution of a method for generating customized model explanations via at least one model is disclosed. The computing device including a processor; a memory; and a communication interface coupled to each of the processor and the memory, wherein the processor may be configured to generate, via the at least one model, a prompt in a natural language format based on a received request for an explanation of at least one model output, the request may include at least one feature attribution and corresponding subject information; modify, via the at least one model, the prompt based on at least one predetermined guideline to generate a test response; validate, via the at least one model, the test response by determining whether at least one error is detected in the test response; perform, via the at least one model when the at least one error is detected, at least one corrective action that resolves each of the at least one detected error by altering the prompt; tune, via the at least one model, the altered prompt based on at least one response attribute; and generate, via the at least one model, a model explanation in the natural language format based on the tuned prompt.

In accordance with an exemplary embodiment, each of the at least one predetermined guideline may relate to an automated prompt modification procedure that is usable to structure data in the prompt, and the automated prompt modification procedure may include a prompt composition requirement and a prompt modification order requirement.

In accordance with an exemplary embodiment, the prompt composition requirement may relate to a predetermined configuration of the data in the prompt, and the prompt composition requirement may include at least one from among a persona requirement that describes a role for adoption by the at least one model, a task outline requirement that references model inputs, a model directive requirement that provides instructions for completing requested tasks, and an input definition requirement that describes the model inputs.

In accordance with an exemplary embodiment, the prompt modification order requirement may relate to a predetermined sequence of modification actions that is usable to change the prompt, and the predetermined sequence may include at least one from among a persona verification action, a task outline verification action, a model directive verification action, and a prompt input verification action.

In accordance with an exemplary embodiment, the validating of the test response may include error determination and self-consistency determination that are performed by the at least one model, the self-consistency determination may relate to a factual accuracy validation of sources utilized by the at least one model.

In accordance with an exemplary embodiment, the error determination may include at least one from among technical error validation that relates to identification of domain concept misinterpretations in the test response and input-output validation that substantiates the test response based on the modified prompt.

In accordance with an exemplary embodiment, the at least one response attribute may define desired output formatting for the model explanation, and the at least one response attribute may include at least one from among a formatting attribute that defines an arrangement of information in the model explanation, a clarity attribute that defines a type of the information for inclusion in the model explanation, and a conciseness attribute that defines an amount of the information for inclusion in the model explanation.

In accordance with an exemplary embodiment, the prompt may correspond to a formulation of natural language text that provides a plurality of instructions to a machine learning model for performance of a task.

In accordance with an exemplary embodiment, the at least one model may include at least one from among a large language model, a deep learning model, a neural network model, a natural language processing model, a machine learning model, a mathematical model, and a process model.

According to an aspect of the present disclosure, a non-transitory computer readable storage medium storing instructions for generating customized model explanations via at least one model is disclosed. The storage medium including executable code which, when executed by a processor, may cause the processor to generate, via the at least one model, a prompt in a natural language format based on a received request for an explanation of at least one model output, the request may include at least one feature attribution and corresponding subject information; modify, via the at least one model, the prompt based on at least one predetermined guideline to generate a test response; validate, via the at least one model, the test response by determining whether at least one error is detected in the test response; perform, via the at least one model when the at least one error is detected, at least one corrective action that resolves each of the at least one detected error by altering the prompt; tune, via the at least one model, the altered prompt based on at least one response attribute; and generate, via the at least one model, a model explanation in the natural language format based on the tuned prompt.

In accordance with an exemplary embodiment, each of the at least one predetermined guideline may relate to an automated prompt modification procedure that is usable to structure data in the prompt, and the automated prompt modification procedure may include a prompt composition requirement and a prompt modification order requirement.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing customized explanations of machine learning model outputs by utilizing automated prompt modification and composition via artificial intelligence.

FIG. 4 is a flowchart of an exemplary process for implementing a method for providing customized explanations of machine learning model outputs by utilizing automated prompt modification and composition via artificial intelligence.

FIG. 5 is a flowchart of an exemplary iterative process for implementing a method for providing customized explanations of machine learning model outputs by utilizing automated prompt modification and composition via artificial intelligence.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

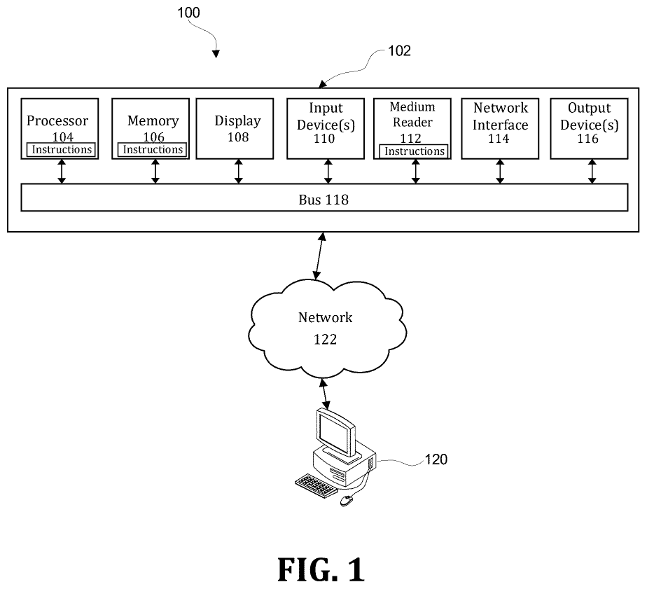

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning system (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a GPS device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing customized explanations of machine learning model outputs by utilizing automated prompt modification and composition via artificial intelligence.

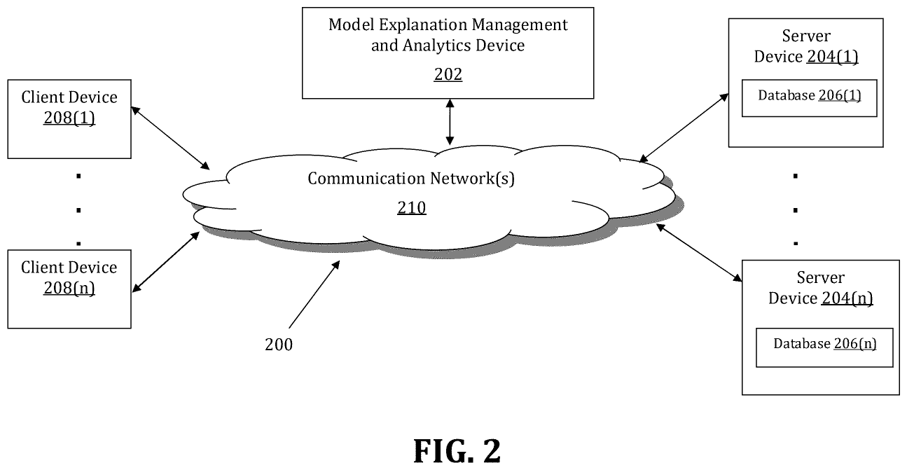

Referring to FIG. 2, a schematic of an exemplary network environment 200 for implementing a method for providing customized explanations of machine learning model outputs by utilizing automated prompt modification and composition via artificial intelligence is illustrated. In an exemplary embodiment, the method is executable on any networked computer platform, such as, for example, a personal computer (PC).

The method for providing customized explanations of machine learning model outputs by utilizing automated prompt modification and composition via artificial intelligence may be implemented by a Model Explanation Management and Analytics (MEMA) device 202. The MEMA device 202 may be the same or similar to the computer system 102 as described with respect to FIG. 1. The MEMA device 202 may store one or more applications that can include executable instructions that, when executed by the MEMA device 202, cause the MEMA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the MEMA device 202 itself, may be located in virtual server(s) running in a cloud-based computing environment rather than being tied to one or more specific physical network computing devices. Also, the application(s) may be running in one or more virtual machines (VMs) executing on the MEMA device 202. Additionally, in one or more embodiments of this technology, virtual machine(s) running on the MEMA device 202 may be managed or supervised by a hypervisor.

In the network environment 200 of FIG. 2, the MEMA device 202 is coupled to a plurality of server devices 204(1)-204(n) that hosts a plurality of databases 206(1)-206(n), and also to a plurality of client devices 208(1)-208(n) via communication network(s) 210. A communication interface of the MEMA device 202, such as the network interface 114 of the computer system 102 of FIG. 1, operatively couples and communicates between the MEMA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the MEMA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and MEMA devices that efficiently implement a method for providing customized explanations of machine learning model outputs by utilizing automated prompt modification and composition via artificial intelligence.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The MEMA device 202 may be a standalone device or integrated with one or more other devices or apparatuses, such as one or more of the server devices 204(1)-204(n), for example. In one particular example, the MEMA device 202 may include or be hosted by one of the server devices 204(1)-204(n), and other arrangements are also possible. Moreover, one or more of the devices of the MEMA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the MEMA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to machine learning models, natural language prompts, requests, model explanations, model outputs, feature attributions, subject information, predetermined guidelines, test responses, errors, corrective actions, and response attributes.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the MEMA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the MEMA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the MEMA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the MEMA device 202, the server devices 204(1)-204(n), or the client devices 208(1)-208(n), for example, may be configured to operate as virtual instances on the same physical machine. In other words, one or more of the MEMA device 202, the server devices 204(1)-204(n), or the client devices 208(1)-208(n) may operate on the same physical device rather than as separate devices communicating through communication network(s) 210. Additionally, there may be more or fewer MEMA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

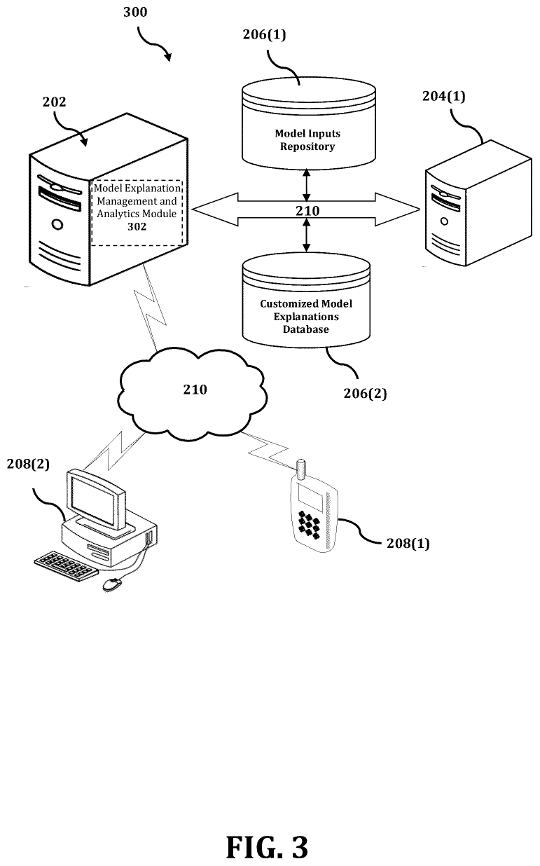

The MEMA device 202 is described and shown in FIG. 3 as including a model explanation management and analytics module 302, although it may include other rules, policies, modules, databases, or applications, for example. As will be described below, the model explanation management and analytics module 302 is configured to implement a method for providing customized explanations of machine learning model outputs by utilizing automated prompt modification and composition via artificial intelligence.

An exemplary process 300 for implementing a mechanism for providing customized explanations of machine learning model outputs by utilizing automated prompt modification and composition via artificial intelligence by utilizing the network environment of FIG. 2 is shown as being executed in FIG. 3. Specifically, a first client device 208(1) and a second client device 208(2) are illustrated as being in communication with MEMA device 202. In this regard, the first client device 208(1) and the second client device 208(2) may be “clients” of the MEMA device 202 and are described herein as such. Nevertheless, it is to be known and understood that the first client device 208(1) and/or the second client device 208(2) need not necessarily be “clients” of the MEMA device 202, or any entity described in association therewith herein. Any additional or alternative relationship may exist between either or both of the first client device 208(1) and the second client device 208(2) and the MEMA device 202, or no relationship may exist.

Further, MEMA device 202 is illustrated as being able to access a model inputs repository 206(1) and a customized model explanations database 206(2). The model explanation management and analytics module 302 may be configured to access these databases for implementing a method for providing customized explanations of machine learning model outputs by utilizing automated prompt modification and composition via artificial intelligence.

The first client device 208(1) may be, for example, a smart phone. Of course, the first client device 208(1) may be any additional device described herein. The second client device 208(2) may be, for example, a PC. Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the MEMA device 202 via broadband or cellular communication. Of course, these embodiments are merely exemplary and are not limiting or exhaustive.

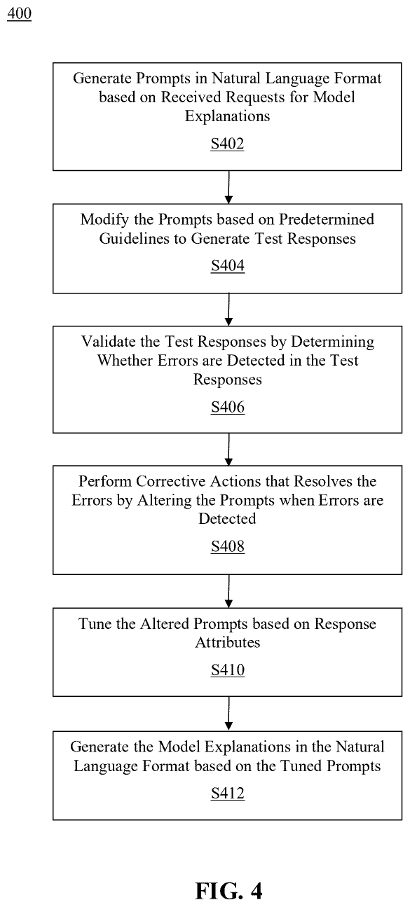

Upon being started, the model explanation management and analytics module 302 executes a process for providing customized explanations of machine learning model outputs by utilizing automated prompt modification and composition via artificial intelligence. An exemplary process for providing customized explanations of machine learning model outputs by utilizing automated prompt modification and composition via artificial intelligence is generally indicated at flowchart 400 in FIG. 4.

In the process 400 of FIG. 4, at step S402, prompts may be generated based on received requests for an explanation of model outputs. The prompts may be generated in a natural language format by using models such as, for example, generative machine learning models. In an exemplary embodiment, the prompts may correspond to a formulation of natural language text that provides a plurality of instructions to a machine learning model for performance of a task. The prompts may provide explicit instructions to the models, which enables the models to produce desired outputs. To facilitate usage of the natural language prompts, the models may utilize natural language processing and deep learning algorithms to examine and comprehend the requests.

In another exemplary embodiment, each of the requests may include feature attributions and corresponding subject information. The feature attributions may include features and corresponding attribution information that indicates how much each feature in the data contributed to a predicted result. The attribution information may include values such as, for example, Shapley Additive Explanations (SHAP) values that are assigned to each feature in the model based on importance. A magnitude of the assigned values may indicate how strong an effect of the corresponding feature is on model outputs. For example, features assigned with positive values may indicate a positive impact on model predictions, while other features with negative values may indicate a negative impact on the model predictions.

Likewise, the corresponding subject information may provide relevant data on a subject of the requests. The subject of the request may include any combination of an individual person, a grouping of people, as well as an organization of people with a particular purpose such as, for example, a business entity. For example, a mortgage applicant may correspond to a subject in an explanation request related to mortgage applications. In another exemplary embodiment, the relevant data on the subject may be automatically aggregated from various sources such as, for example, first party and third party sources based on information provided by the requests. For example, the request may include identifying information that is usable to retrieve additional data about a particular subject from a data aggregator.

In another exemplary embodiment, the models may include at least one from among a large language model, a deep learning model, a neural network model, a natural language processing model, a machine learning model, a mathematical model, and a process model. The models may also include stochastic models such as, for example, Markov models that are usable to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, support vector machine (SVM) analysis, logistic regression analysis, etc. In another exemplary embodiment, machine learning analytical techniques may include unsupervised learning algorithms such as, for example, Apriori algorithm analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the machine learning process may include a neural network that relates to at least one from among an artificial neural network and a simulated neural network. The neural network may correspond to a technique in artificial intelligence that teaches computers to process data by using interconnected processing nodes and/or artificial neurons. The neural network may relate to a type of machine learning such as, for example, deep learning that uses interconnected nodes and/or artificial neurons in a layered structure to transform inputs for predictive analytics.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

In another exemplary embodiment, the large language model may relate to a trained deep-learning model that understands and generates text in a human-like fashion. The large language model may recognize, summarize, translate, predict, and generate various types of text as well as content based on knowledge gained from massive data sets. In another exemplary embodiment, the large language model may correspond to a language model that consists of a neural network with many parameters such as, for example, weights. The language model may be trained on large quantities of unlabeled and labeled text by using self-supervised learning or semi-supervised learning. The trained language model may be usable to capture syntax and semantics of human language.

In another exemplary embodiment, the natural language processing model may correspond to a plurality of natural language processing techniques. The natural language processing techniques may include at least one from among a sentiment analysis technique, a named entity recognition technique, a summarization technique, a topic modeling technique, a text classification technique, a keyword extraction technique, and a lemmatization and stemming technique. As will be appreciated by a person of ordinary skill in the art, natural language processing may relate to computer processing and analyzing of large quantities of natural language data.

In another exemplary embodiment, the requests may be received as inputs from users. The inputs may be received via a graphical user interface that includes graphical elements, which are usable to represent information as well as to receive the information as the user inputs. The graphical user interface may communicate with the disclosed system via a communication interface such as, for example, an application programming interface. In another exemplary embodiment, the application programming interface may facilitate communication between the disclosed system and various other computing platforms and applications. The disclosed system may communicate with the computing platforms and the applications to facilitate receipt of the requests.

In another exemplary embodiment, the applications may include at least one from among a monolithic application and a microservice application. The monolithic application may describe a single-tiered software application where the user interface and data access code are combined into a single program from a single platform. The monolithic application may be self-contained and independent from other computing applications.

In another exemplary embodiment, a microservice application may include a unique service and a unique process that communicates with other services and processes over a network to fulfill a goal. The microservice application may be independently deployable and organized around business capabilities. In another exemplary embodiment, the microservices may relate to a software development architecture such as, for example, an event-driven architecture made up of event producers and event consumers in a loosely coupled choreography. The event producer may detect or sense an event such as, for example, a significant occurrence or change in state for system hardware or software and represent the event as a message. The event message may then be transmitted to the event consumer via event channels for processing.

In another exemplary embodiment, the event-driven architecture may include a distributed data streaming platform for the publishing, subscribing, storing, and processing of event streams in real time. As will be appreciated by a person of ordinary skill in the art, each microservice in a microservice choreography may perform corresponding actions independently and may not require any external instructions.

In another exemplary embodiment, microservices may relate to a software development architecture such as, for example, a service-oriented architecture which arranges a complex application as a collection of coupled modular services. The modular services may include small, independently versioned, and scalable customer-focused services with specific business goals. The services may communicate with other services over standard protocols with well-defined interfaces. In another exemplary embodiment, the microservices may utilize technology-agnostic communication protocols such as, for example, a Hypertext Transfer Protocol (HTTP) to communicate over a network and may be implemented by using different programming languages, databases, hardware environments, and software environments.

At step S404, the prompts may be modified based on predetermined guidelines. The prompts may be modified by using the models to generate test responses. In an exemplary embodiment, each of the predetermined guidelines may relate to an automated prompt modification procedure that is usable to structure data in the prompt. The automated prompt modification procedure may include a prompt composition requirement and a prompt modification order requirement. The automated prompt modification procedure may be manually adjusted based on user input as well as automatically adjusted by the models based on established criteria such as, for example, efficiency thresholds.

In another exemplary embodiment, the prompt composition requirement may relate to a predetermined configuration of the data in the prompts. The prompt composition requirement may include at least one from among a persona requirement that describes a role for adoption by the models, a task outline requirement that references model inputs, a model directive requirement that provides instructions for completing requested tasks, and an input definition requirement that describes the model inputs. For example, the prompt composition requirement may indicate that the prompt must include one line/sentence that describes the role for adoption by the model, two lines/sentences that reference model inputs and outlines a requested task, one line/sentence that provides instructions for completing requested tasks, as well as one line/sentence that describes the input specifications and/or definitions.

In another exemplary embodiment, the prompt modification order requirement may relate to a predetermined sequence of modification actions that is usable to change the prompts. The predetermined sequence includes at least one from among a persona verification action, a task outline verification action, a model directive verification action, and a prompt input verification action.

For example, the prompt modification order requirement may include a specific sequence of four modification actions that must be followed by the models when modifying the prompts. The specific sequence may be determined to customize/personalize the prompts for improved accuracy of model outputs as well as to improve resource efficiency by reducing required iterations necessary for usable model outputs. The specific sequence may include a first step that determines whether first lines in the prompts contain a user persona/role information. No changes to the first lines are necessary when the user persona/role information is detected, else a line/sentence may be inserted into the prompt to provide the user persona/role information.

Likewise, the specific sequence may include a second step that determines whether second and subsequent lines in the prompts contain task outlines. When there is no mention of inputs, the prompts may be modified to add an extra line to mention prompt inputs to tasks. Else, when machine learning models are mentioned as inputs to task, the prompts may be modified to replace machine learning model information with prompt inputs. Thus, when prompt inputs are mentioned, no changes may be necessary to the prompts. Moreover, the prompts may be modified in the second step to delete all lines between the first line, which provides information relating to personas, and the lines providing information about the task outlines.

Furthermore, the specific sequence may include a third step that determines whether lines subsequent to the task outlines contain model directives. When no model directives on using prompt inputs are provided, the prompts may be modified to append directives on prompt input usage by the models. Else, when model directives mention machine learning models, the prompts may be modified to replace the mentioned machine learning models with prompt inputs. Additionally, the prompts may be modified in the third step to delete all lines between lines providing information about the task outlines and lines providing information about the model directives. Then, the specific sequence may include a fourth step that provides prompt inputs to facilitate the prompt modifications.

Consistent with present disclosures, the modified prompts may provide explicit instructions to the models to enable production of desired outputs by the models. To facilitate usage of the natural language in the modified prompts, the models may utilize natural language processing and deep learning algorithms to examine and comprehend the requests. Whenever the models are given the modified prompts, the models may go through patterns that have been learned from corresponding training data, which may include large data sets, to generate responses such as, for example, the test responses that are contextually relevant to the input. This process may be referred to as an inference process that involves computing probabilities of various word sequences and correlations based on both the modified prompts and the training data.

Thus, for successful generation of desired outputs such as, for example, the test responses, the modified prompts may need to be highly specific. For example, generic prompts such as “explain why an applicant does not qualify” may result in generic outputs from the models. However, by offering more precise details such as applicant information, persona information, task outline information, model directive information, and input definition information, the models may generate desired outputs. Specificity in the modified prompts may also remove the likelihood of inaccurate outputs.

At step S406, the test responses may be validated by determining whether errors are detected in the test response. The test responses may be validated by using the models. In an exemplary embodiment, the validating of the test response may include error determination and self-consistency determination that are performed by the models. The validating of the test response may relate to response validation and error analysis actions.

In another exemplary embodiment, the self-consistency determination may relate to a factual accuracy validation of sources that are utilized by the models. The self-consistency determination may be automatically completed by the models to analyze the test responses for factual errors and/or model hallucinations. For example, the models may be used to check the factual accuracy of the test response of another instance. The self-consistency determination may correspond to self-consistency checking and source verification actions that are automatically initiated by the models.

In another exemplary embodiment, the error determination may include at least one from among technical error validation and input-output validation. The technical error validation may relate to processes that facilitate identification of domain concept misinterpretations in the test responses. For example, the technical error validation processes may check the test responses for technical errors and/or domain concept misinterpretations such as incorrect interpretation of Shapley values.

Moreover, the input-output validation may relate to processes that substantiate the test responses based on the modified prompt. The input-output validation processes may correspond to prompt-response validation actions that validate model outputs such as, for example, the test responses for a given input such as, for example, the modified prompts. Thresholds for the validation may be adjusted based on criteria such as, for example, resource efficiency criteria. For example, validation thresholds may be automatically adjusted to be less strict with regards to the test responses covering every aspect of the modified prompts.

At step S408, corrective actions may be performed by using the models when the errors are detected in the test responses. The corrective actions may be performed to resolve each of the detected errors by altering the prompts. In an exemplary embodiment, the prompts may be automatically altered to address detected errors within the test responses. The corrective actions to facilitate the automated altering of the prompts may be automatically identified by the models based on characteristics of the detected errors such as, for example, error type characteristics. Once identified, the corrective actions may be automatically initiated based on a magnitude of impact corresponding to each of the errors. The magnitude of impact may be automatically determined by the models based on information such as, for example, historical impact information.

At step S410, the altered prompts may be tuned based on response attributes. The altered prompts may be tuned by using the models. In an exemplary embodiment, the tuning of the altered prompts may correspond to a fine-tuning process that modifies the altered prompts based on a desired output. While the process is described as a fine-tuning process, any combination of small and large adjustments may be performed on the altered prompts.

In another exemplary embodiment, the response attributes may define desired output customizations for the model explanations. The response attributes may include at least one from among a formatting attribute, a clarity attribute, and a conciseness attribute. More specifically, the formatting attribute may define an arrangement of information in the model explanations. For example, the formatting attribute may indicate that the model explanations are generated in a natural language format with information specifically structured based on user preferences.

Likewise, the clarity attribute may define a type of information for inclusion in the model explanations. For example, the clarity attribute may indicate that the model explanations are generated with common words and/or phrases instead of specialized technical terminology. Furthermore, the conciseness attribute may define an amount of the information for inclusion in the model explanation. For example, the conciseness attribute may indicate that the model explanations are generated to provide a summation of the information rather than the information in its entirety.

At step S412, model explanations may be generated in the natural language format based on the tuned prompts. The model explanations may be generated by using the models according to the response attributes in the tuned prompts. In an exemplary embodiment, the model explanations may relate to explanations in which explanans appeal to certain properties and/or behaviors that are observed in an idealized model and/or computer simulation as part of an explanation for what the explanandum phenomenon exhibits the features that it does. The explanandum may relate to a sentence describing a phenomenon that is to be explained and the explanans may relate to sentences that are adduced as explanations of said phenomenon. For example, the model explanations may provide a rationale and supporting information in the natural language format as to why the models have made certain determinations regarding an applicant.

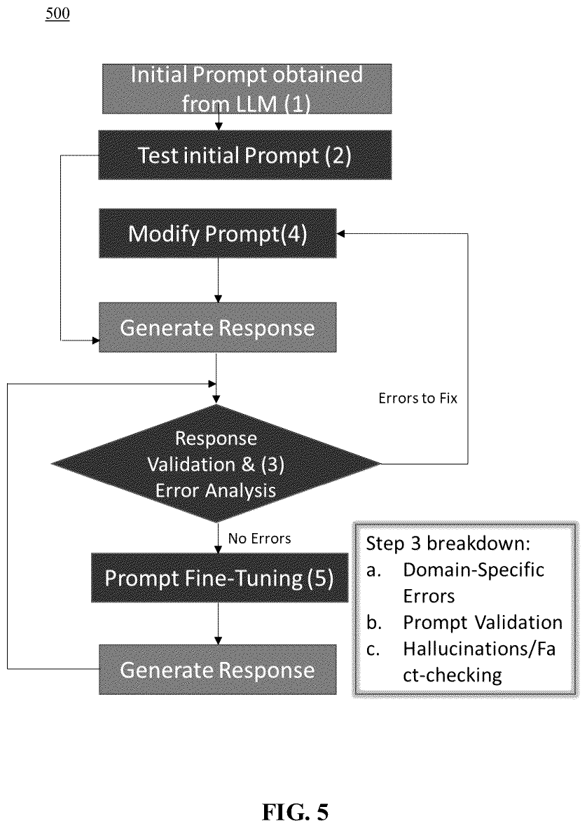

FIG. 5 is a flowchart of an exemplary iterative process for implementing a method for providing customized explanations of machine learning model outputs by utilizing automated prompt modification and composition via artificial intelligence. In FIG. 5, an exemplary iterative process is provided to facilitate personalization of generated content based on individual needs by using automated prompt modification procedures and automatic prompt generators that are tailored for personalization. Consistent with present disclosures, the provided prompt tuning may enable generation of optimal model outputs.

As illustrated in FIG. 5, at step 1, initial prompts may be obtained from a machine learning model such as, for example, a large language model. At step 2, the initial prompts may be tested by generating corresponding test responses. At step 3, validation and error analysis may be performed on the test responses to determine whether errors are detected in the test responses. The validation and error analysis may include checks for domain-specific errors, prompt validations, and hallucinations/fact-checking actions. When no errors are detected, the initial prompts are fine-tuned at step 5 based on response attributes for desired outputs. Then, the model explanations may be generated based on the fine-tuned prompts.

Alternatively, when errors are detected, the initial prompts may be modified at step 4 to correct the detected errors. Once the detected errors have been corrected, new test responses may be generated based on the modified prompts for validation and error analysis consistent with step 3. When no new errors are detected in the new test responses, the modified prompts are fine-tuned at step 5 based on the response attributes for desired outputs. Then, similar to the above disclosure, the model explanations may be generated based on the fine-tuned prompts.

Accordingly, with this technology, an optimized process for providing customized explanations of machine learning model outputs by utilizing automated prompt modification and composition via artificial intelligence is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for generating customized model explanations via at least one model, the method being implemented by at least one processor, the method comprising:
generating, by the at least one processor via the at least one model, a prompt in a natural language format based on a received request for an explanation of at least one model output, the request including at least one feature attribution and corresponding subject information;
modifying, by the at least one processor via the at least one model, the prompt based on at least one predetermined guideline to generate a test response;
validating, by the at least one processor via the at least one model, the test response by determining whether at least one error is detected in the test response;
performing, by the at least one processor via the at least one model when the at least one error is detected, at least one corrective action that resolves each of the at least one detected error by altering the prompt;
tuning, by the at least one processor via the at least one model, the altered prompt based on at least one response attribute; and
generating, by the at least one processor via the at least one model, a model explanation in the natural language format based on the tuned prompt.

2. The method of claim 1, wherein each of the at least one predetermined guideline relates to an automated prompt modification procedure that is usable to structure data in the prompt, and
wherein the automated prompt modification procedure includes a prompt composition requirement and a prompt modification order requirement.

3. The method of claim 2, wherein the prompt composition requirement relates to a predetermined configuration of the data in the prompt, and
wherein the prompt composition requirement includes at least one from among a persona requirement that describes a role for adoption by the at least one model, a task outline requirement that references model inputs, a model directive requirement that provides instructions for completing requested tasks, and an input definition requirement that describes the model inputs.

4. The method of claim 2, wherein the prompt modification order requirement relates to a predetermined sequence of modification actions that is usable to change the prompt, and
wherein the predetermined sequence includes at least one from among a persona verification action, a task outline verification action, a model directive verification action, and a prompt input verification action.

5. The method of claim 1, wherein the validating of the test response includes error determination and self-consistency determination that are performed by the at least one model, the self-consistency determination relating to a factual accuracy validation of sources utilized by the at least one model.

6. The method of claim 5, wherein the error determination includes at least one from among technical error validation that relates to identification of domain concept misinterpretations in the test response and input-output validation that substantiates the test response based on the modified prompt.

7. The method of claim 1, wherein the at least one response attribute defines desired output formatting for the model explanation, and
wherein the at least one response attribute includes at least one from among a formatting attribute that defines an arrangement of information in the model explanation, a clarity attribute that defines a type of the information for inclusion in the model explanation, and a conciseness attribute that defines an amount of the information for inclusion in the model explanation.

8. The method of claim 1, wherein the prompt corresponds to a formulation of natural language text that provides a plurality of instructions to a machine learning model for performance of a task.

9. The method of claim 1, wherein the at least one model includes at least one from among a large language model, a deep learning model, a neural network model, a natural language processing model, a machine learning model, a mathematical model, and a process model.

10. A computing device configured to implement an execution of a method for generating customized model explanations via at least one model, the computing device comprising:
a processor;
a memory; and
a communication interface coupled to each of the processor and the memory,
wherein the processor is configured to:
generate, via the at least one model, a prompt in a natural language format based on a received request for an explanation of at least one model output, the request including at least one feature attribution and corresponding subject information;
modify, via the at least one model, the prompt based on at least one predetermined guideline to generate a test response;
validate, via the at least one model, the test response by determining whether at least one error is detected in the test response;
perform, via the at least one model when the at least one error is detected, at least one corrective action that resolves each of the at least one detected error by altering the prompt;
tune, via the at least one model, the altered prompt based on at least one response attribute; and
generate, via the at least one model, a model explanation in the natural language format based on the tuned prompt.

11. The computing device of claim 10, wherein each of the at least one predetermined guideline relates to an automated prompt modification procedure that is usable to structure data in the prompt, and
wherein the automated prompt modification procedure includes a prompt composition requirement and a prompt modification order requirement.

12. The computing device of claim 11, wherein the prompt composition requirement relates to a predetermined configuration of the data in the prompt, and
wherein the prompt composition requirement includes at least one from among a persona requirement that describes a role for adoption by the at least one model, a task outline requirement that references model inputs, a model directive requirement that provides instructions for completing requested tasks, and an input definition requirement that describes the model inputs.

13. The computing device of claim 11, wherein the prompt modification order requirement relates to a predetermined sequence of modification actions that is usable to change the prompt, and
wherein the predetermined sequence includes at least one from among a persona verification action, a task outline verification action, a model directive verification action, and a prompt input verification action.

14. The computing device of claim 10, wherein the validating of the test response includes error determination and self-consistency determination that are performed by the at least one model, the self-consistency determination relating to a factual accuracy validation of sources utilized by the at least one model.

15. The computing device of claim 14, wherein the error determination includes at least one from among technical error validation that relates to identification of domain concept misinterpretations in the test response and input-output validation that substantiates the test response based on the modified prompt.

16. The computing device of claim 10, wherein the at least one response attribute defines desired output formatting for the model explanation, and
wherein the at least one response attribute includes at least one from among a formatting attribute that defines an arrangement of information in the model explanation, a clarity attribute that defines a type of the information for inclusion in the model explanation, and a conciseness attribute that defines an amount of the information for inclusion in the model explanation.

17. The computing device of claim 10, wherein the prompt corresponds to a formulation of natural language text that provides a plurality of instructions to a machine learning model for performance of a task.

18. The computing device of claim 10, wherein the at least one model includes at least one from among a large language model, a deep learning model, a neural network model, a natural language processing model, a machine learning model, a mathematical model, and a process model.

19. A non-transitory computer readable storage medium storing instructions for generating customized model explanations via at least one model, the storage medium comprising executable code which, when executed by a processor, causes the processor to:
generate, via the at least one model, a prompt in a natural language format based on a received request for an explanation of at least one model output, the request including at least one feature attribution and corresponding subject information;
modify, via the at least one model, the prompt based on at least one predetermined guideline to generate a test response;
validate, via the at least one model, the test response by determining whether at least one error is detected in the test response;
perform, via the at least one model when the at least one error is detected, at least one corrective action that resolves each of the at least one detected error by altering the prompt;
tune, via the at least one model, the altered prompt based on at least one response attribute; and
generate, via the at least one model, a model explanation in the natural language format based on the tuned prompt.

20. The storage medium of claim 19, wherein each of the at least one predetermined guideline relates to an automated prompt modification procedure that is usable to structure data in the prompt, and
wherein the automated prompt modification procedure includes a prompt composition requirement and a prompt modification order requirement.
